(19) United States
(12) Patent Application Publication
(10) Pub. No.: US 2023/0065966 A1
(43) Pub. Date: Mar. 2, 2023

(54) SYSTEM FOR CROSS-CHAIN REAL-TIME VERIFICATION OF EVENTS IN A MULTI-STEP ELECTRONIC PROCESS

(71) Applicant: BANK OF AMERICA CORPORATION, Charlotte, NC (US)

(72) Inventors: Richard C. Clow, II, Morristown, NJ (US); Charles Russell Kendall, Snoqualmie, WA (US)

(73) Assignee: BANK OF AMERICA CORPORATION, Charlotte, NC (US)

(21) Appl. No.: 17/410,543

(22) Filed: Aug. 24, 2021

(51) Int. Cl. G06Q 20/40; G06Q 20/02

(52) U.S. Cl. CPC G06Q 20/401; G06Q 20/02

(57) ABSTRACT

Systems, computer program products, and methods are described herein for generating pre-authorized request for conditional resource transfers within a real-time resource transfer network in response to supply chain updates. The present invention is configured to electronically receive, from a computing device of a user, a request to establish a resource transfer program within a real-time payment (RTP) network, with a third party for acquisition of an item or product; generate the resource transfer program, wherein generating further comprises generating one or more requests for resource transfers (RRTs) to be fulfilled by the user; transmit control signals configured to cause the computing device of the user to display the one or more RRTs; in response, electronically receive, from the computing device of the user, an acknowledgement of the one or more RRTs; and generate a virtual dynamic resource transfer hold pre-authorizing fulfillment.

### FIELD OF THE INVENTION

The present invention embraces a system for generating and executing pre-authorized request for conditional resource transfers within a real-time resource transfer network.

### BACKGROUND

The evolution of the payment infrastructure has brought us to an era where convenient, secure, and agile payment solutions are revolutionizing the way money is exchanged and business gets done. With increased flexibility and control for individuals, clarity and cash flow for businesses, and new opportunities for growth for entities, real-time payments provide significant advantages.

There is a need, within the real-time resource transfer infrastructure, for a system for generating and executing pre-authorized request for conditional resource transfers within a real-time resource transfer network.

### BRIEF SUMMARY

The following presents a simplified summary of one or more embodiments of the present invention, in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

In one aspect, a system for generating pre-authorized request for periodic resource transfers within a real-time resource transfer network is presented. The system comprising: at least one non-transitory storage device; and at least one processing device coupled to the at least one non-transitory storage device, wherein the at least one processing device is configured to: electronically receive, from a user device of a user, a request to establish a resource transfer program within a real-time payment (RTP) network, with a third party for acquisition of an item or product; generate the resource transfer program based on at least receiving the request from the user, wherein generating further comprises generating one or more requests for resource transfers (RRTs) to be fulfilled by the user; transmit control signals configured to cause the user device of the user to display the one or more RRTs; in response, electronically receive, from the user device of the user, an acknowledgement of the one or more RRTs; electronically receive resource data verifying completion of one or more conditions precedent from the user or the third party; submit a proposal to a distributed ledger containing the resource data; and authorize fulfillment of at least a portion of resources of the one or more RRTs in response to receiving the resource data from the user or the third party.

In some embodiments, the invention is further configured to: retrieve from the request, resource transfer information associated with the resource transfer program, wherein the resource transfer information comprises at least information associated with the user, information associated with the item or product, and information associated with the third party.

In some embodiments, the invention is further configured to: electronically receive, from a user device of the third party, the one or more conditions precedent associated with the resource transfer program; and generate the one or more RRTs based on at least the resource transfer information and the one or more conditions precedent associated with the resource transfer program.

In some embodiments, the one or more conditions precedent associated with the resource transfer program comprise, for each of the one or more RRTs, at least a resource transfer date, a resource transfer time, a resource transfer amount, and an action required on the user or third party's behalf prior to authorization of the resource transfer amount.

In some embodiments, the invention is further configured to: determine that the resource transfer program is a recurring action comprising one or more periodic resource transfers; and generate the one or more RRTs for the one or more periodic resource transfers.

In some embodiments, the invention is further configured to: at each recurring period, automatically authorize, via the RTP network, fulfillment of at least one of the one or more RRTs, wherein authorizing further comprises executing a real-time resource transfer of at least one of the one or more periodic resource transfers.

In some embodiments, the invention is further configured to: transmit control signals configured to cause the computing device of the user to display a notification indicating the fulfillment of at least one the conditions precedent, and indicating the authorization of at least a portion of resources.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 illustrates an operating environment for a system for cross-chain real-time verification of events, in accordance with some embodiments of the invention;

FIG. 2 is a block diagram illustrating the various components of a real-time verification system, in accordance with some embodiments of the invention;

FIG. 3 is a block diagram illustrating a user device associated with the real-time verification system, in accordance with some embodiments of the invention;

FIG. 4 is a block diagram illustrating an operating environment for a distributed trust computing network, in accordance with some embodiments of the invention; and

FIG. 5 is a process flow diagram for generating and executing pre-authorized request for conditional resource transfers within a real-time resource transfer network, in accordance with some embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

“Entity” or “managing entity” as used herein may refer to any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a credit account, or the like. The account is associated with and/or maintained by the entity. In other embodiments, an entity may not be a financial institution. In still other embodiments, the entity may be the merchant itself.

“Entity system” or “managing entity system” as used herein may refer to the computing systems, devices, software, applications, communications hardware, and/or other resources used by the entity to perform the functions as described herein. Accordingly, the entity system may comprise desktop computers, laptop computers, servers, Internet-of-Things (“IoT”) devices, networked terminals, mobile smartphones, smart devices (e.g., smart watches), network connections, and/or other types of computing systems or devices and/or peripherals along with their associated applications.

As described herein, a “user” may be an individual associated with an entity. As such, in some embodiments, the user may be an individual having past relationships, current relationships or potential future relationships with an entity. In some embodiments, a “user” may be an employee (e.g., an associate, a project manager, an IT specialist, a manager, an administrator, an internal operations analyst, or the like) of the entity or enterprises affiliated with the entity, capable of operating the systems described herein. In some embodiments, a “user” may be any individual, entity or system who has a relationship with the entity, such as a customer or a prospective customer. In other embodiments, a user may be a system performing one or more tasks described herein.

As used herein, a “user interface” may be any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user second user or output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, and/or one or more devices, nodes, clusters, or systems within the system environment described herein. For example, an interaction may refer to a transfer of data between devices, an accessing of stored data by one or more nodes of a computing cluster, a transmission of a requested task, or the like.

As used herein, a “resource” may generally refer to objects, products, devices, goods, commodities, services, and the like, and/or the ability and opportunity to access and use the same. Some example implementations herein contemplate a market value of a property held by a user, including property that is stored and/or maintained by a third-party entity. For purposes of this invention, a resource is typically stored in a resource repository—a storage location where one or more resources are organized, stored and retrieved electronically using a computing device.

As used herein, a “resource transfer,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. In the context of an entity such as a financial institution, a resource transfer may refer to one or more of: a sale of goods and/or services, a user accessing their e-wallet, or any other interaction involving the user and/or the user's device that invokes or is detectable by the financial institution. In some embodiments, the user may authorize a resource transfer using at least a payment instrument (credit cards, debit cards, checks, digital wallets, digital currency, loyalty points, or the like), and/or payment credentials (account numbers, payment instrument identifiers). Unless specifically limited by the context, a “resource transfer” a “transaction”, “transaction event” or “point of transaction event” may refer to any activity between a user, a merchant, an entity, or any combination thereof. In some embodiments, a resource transfer may refer to the purchase of digital content, wherein the ownership of the digital content is transferred between users, or purchase of the right of access to digital content, wherein one or more users may pay to view, listen to, or otherwise experience or use digital content, but ownership of the content does not change in the course of the resource transfer. In some embodiments, resource transfers may be automatically initiated upon recognition that one or more users has accessed certain content, and the system may facilitate the movement of resources between accounts such that the verified owner of digital content is paid accordingly.

As used herein, “payment instrument” may refer to an electronic payment vehicle, such as an electronic credit or debit card. The payment instrument may not be a “card” at all and may instead be account identifying information stored electronically in a user device, such as payment credentials or tokens/aliases associated with a digital wallet, or account identifiers stored by a mobile application. In accordance with embodiments of the invention, the term “module” with respect to an apparatus may refer to a hardware component of the apparatus, a software component of the apparatus, or a component of the apparatus that comprises both hardware and software. In accordance with embodiments of the invention, the term “chip” may refer to an integrated circuit, a microprocessor, a system-on-a-chip, a microcontroller, or the like that may either be integrated into the external apparatus or may be inserted and removed from the external apparatus by a user.

As defined herein, “real-time” may be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In some embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, or the like. However, in many embodiments, the time delay can be less than approximately one second, five seconds, ten seconds, thirty seconds, one minute, or five minutes.

In some embodiments, an internally managed and locally decentralized private blockchain is proposed as a decentralized and trusted storage and data transfer solution, or “distributed register database.” It is understood that in such embodiments, the owning organization or entity of the system will have authority to sign or write to the chain, producing faster output and offering privacy and security to the contents of the chain. In other implementations, for example, where one or more third party entities or organizations utilize the present invention, it may be preferable to employ a public blockchain retaining the benefits of a truly decentralized storage mechanism, but offering selective permissioned access to a public or a semi-public portal for management, access, and transfer of resources or content stored on the public blockchain. It is understood that preferred embodiments of the invention rely on particular distributed registers which utilize a programming language allowing for the creation and management of smart contracts (e.g., Solidity, or the like). It is understood that “smart contract” does not necessarily constitute a valid binding agreement at law, but rather the notion of general purpose computation that takes place on a blockchain or distributed ledger which allows for the transfer of resources in a trustless manner after the verification or acknowledgment of some condition precedent. It is understood that “trustless” as used herein refers to the idea that a transaction or transfer of resources may take place without the use of a trusted intermediary between the payor and payee.

As discussed, in some embodiments, the present invention also includes a publicly or semi-publicly accessible feature or “portal” wherein one or more entities or users may utilize the system for content verification and management purposes. In some embodiments, this may be a public facing portal which allows a user to upload or submit digital content. In instances of authenticity or ownership verification, the portal will then process the content, extract the embedded blockchain signature, and then either forward the signature to a processing system or process it locally on the extracting server. The processing system will compare the embedded blockchain signature with the data from the distributed register and validate that the embedded signature and the data stored on the system and the blockchain match. This response is then presented back to the requesting user thereby giving them an authoritative response as to the ownership and access rights of the content. In some embodiments, the portal may aid in the proper authorization of access to and distribution of digital content stored on the blockchain. The portal also provides a way to ascertain if content is being used by third parties without explicit permission by comparing data signatures of custodied content against data sourced from other entities or parties in order to identify unauthorized copying or distribution.

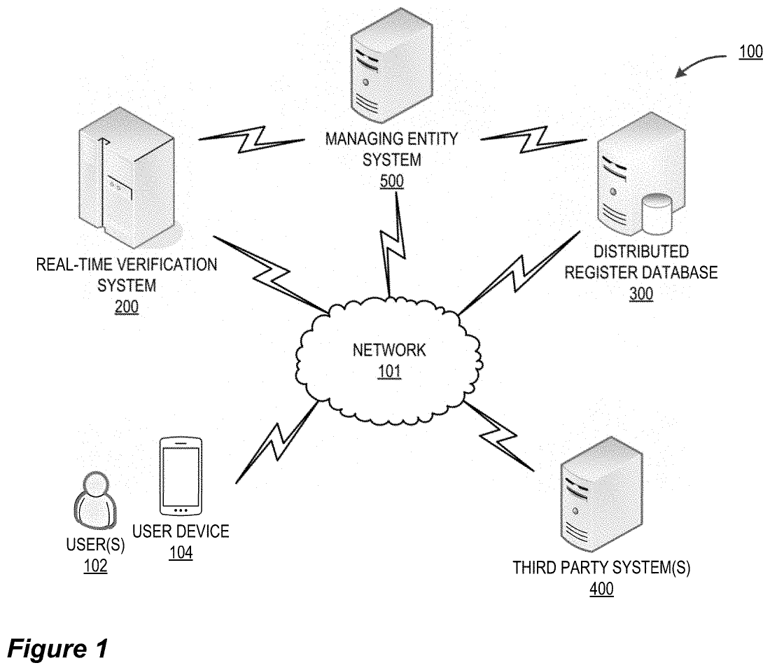

FIG. 1 illustrates an operating environment for a real-time verification system, in accordance with one embodiment of the present disclosure. As illustrated, the operating environment 100 may comprise a user 102 and/or a user device 104 in operative communication with one or more third party systems 400 (e.g., web site hosts, registry systems, databases, third party entity systems, or the like). The operative communication may occur via a network 101 as depicted, or the user 102 may be physically present at a location separate from the various systems described, utilizing the systems remotely. The operating environment includes a managing entity system 500, a real-time verification system 200, a distributed register 300, and/or other systems/devices not illustrated herein and connected via a network 101. As such, the user 102 may request information from or utilize the services of the real-time verification system 200, or the third party system 400 by establishing operative communication channels between the user device 104, the managing entity system 500, and the third party system 400 via a network 101.

Typically, the real-time verification system 200 and the distributed register 300 are in operative communication with the managing entity system 500, via the network 101, which may be the internet, an intranet or the like. In FIG. 1, the network 101 may include a local area network (LAN), a wide area network (WAN), a global area network (GAN), and/or near field communication (NFC) network. The network 101 may provide for wireline, wireless, or a combination of wireline and wireless communication between devices in the network. In some embodiments, the network 101 includes the Internet. In some embodiments, the network 101 may include a wireless telephone network. Furthermore, the network 101 may comprise wireless communication networks to establish wireless communication channels such as a contactless communication channel and a near field communication (NFC) channel (for example, in the instances where communication channels are established between the user device 104 and the third party system 400). In this regard, the wireless communication channel may further comprise near field communication (NFC), communication via radio waves, communication through the internet, communication via electromagnetic waves and the like.

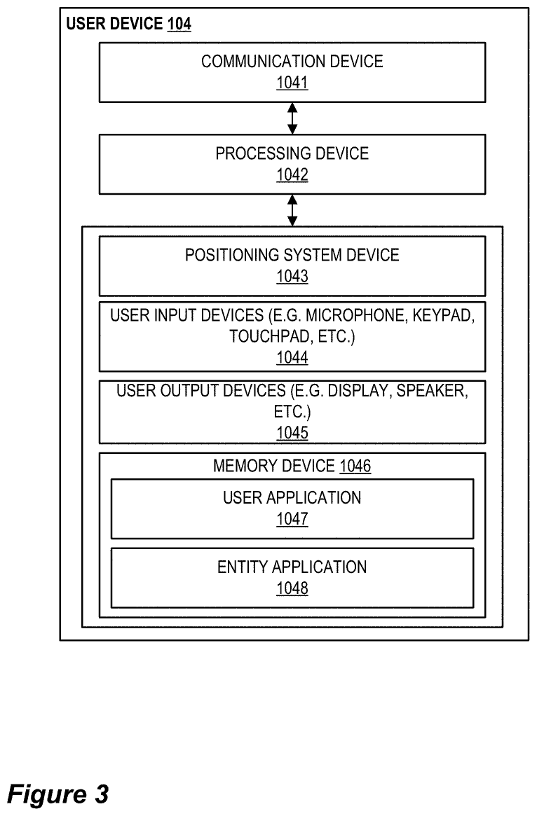

The user device 104 may comprise a mobile communication device, such as a cellular telecommunications device (i.e., a smart phone or mobile phone), a computing device such as a laptop computer, a personal digital assistant (PDA), a mobile internet accessing device, or other mobile device including, but not limited to portable digital assistants (PDAs), pagers, mobile televisions, laptop computers, cameras, video recorders, audio/video player, radio, GPS devices, any combination of the aforementioned, or the like. The user device is described in greater detail with respect to FIG. 3.

The managing entity system 500 may comprise a communication module and memory not illustrated, and may be configured to establish operative communication channels with a third party system 400 and/or a user device 104 via a network 101. The managing entity may comprise a data repository 256 which stores user account data 257. The data repository 256 may also contain user data. This user data may be used by the managing entity to authorize or validate the identity of the user 102 for accessing the system (e.g., via a username, password, biometric security mechanism, 2 factor authentication mechanism, or the like). In some embodiments, the managing entity system is in operative communication with the real-time verification system 200 and distributed register 300 via a private communication channel. The private communication channel may be via a network 101 or the real-time verification system 200 and distributed register 300 may be fully integrated within the managing entity system 500, such as a virtual private network (VPN), or over a secure socket layer (SSL).

The managing entity system 500 may communicate with the real-time verification system 200 in order to transmit data by or via a plurality of third party systems 400. In some embodiments, the managing entity may utilize the features and functions of the real-time verification system 200 to generate a smart contract for remittance based on conditions set by two or more parties. In other embodiments, the managing entity and/or the one or more third party systems may utilize the real-time verification system 200 via a portal or application in order to query the distributed register 300 for verification purposes. In some embodiments, this may be a public facing portal which allows a user to configure smart contracts with other users, check their status, and manage their resources. The portal or entity application of the real-time verification system 200 may also provide a way to ascertain if conditions precedent have been met (e.g., products picked up by shipper, products delivered, services rendered, or the like), and the status of resources transferred as a result.

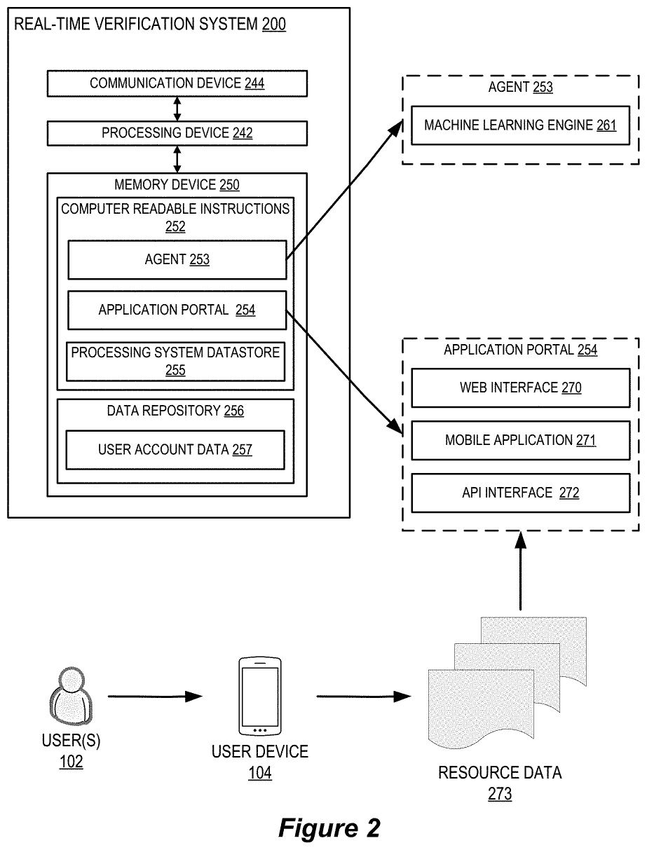

FIG. 2 illustrates a block diagram of the real-time verification system 200 associated with the operating environment 100, in accordance with embodiments of the present invention. As illustrated in FIG. 2, the real-time verification system 200 may include a communication device 244, a processing device 242, and a memory device 250 having an agent module or “agent” 253 (e.g., an application or coded automation for interfacing with one or more other systems, such as the distributed register database 300 or distributed trust computing network 401), an application portal 254 and a processing system datastore 255 stored therein. As shown, the processing device 242 is operatively connected to and is configured to control and cause the communication device 244, and the memory device 250 to perform one or more functions. In some embodiments, the agent module 253 and/or the application portal 254 comprises computer readable instructions that when executed by the processing device 242 cause the processing device 242 to perform one or more functions and/or transmit control instructions to the distributed register 300, the managing entity system 500, or the communication device 244. It will be understood that the agent 253 or the application portal 254 may be executable to initiate, perform, complete, and/or facilitate one or more portions of any embodiments described and/or contemplated herein. The agent 253 may comprise executable instructions associated with data processing and analysis related to retrieval and submission of block chain data. The real-time verification system 200 may be owned by, operated by and/or affiliated with the same managing entity that owns or operates the managing entity system 500. In some embodiments, the real-time verification system 200 is fully integrated within the managing entity system 500.

The machine learning engine 261 may receive data from a plurality of sources and, using one or more machine learning algorithms, may generate one or more machine learning datasets 262. Various machine learning algorithms may be used without departing from the invention, such as supervised learning algorithms, unsupervised learning algorithms, regression algorithms (e.g., linear regression, logistic regression, and the like), instance based algorithms (e.g., learning vector quantization, locally weighted learning, and the like), regularization algorithms (e.g., ridge regression, least-angle regression, and the like), decision tree algorithms, Bayesian algorithms, clustering algorithms, artificial neural network algorithms, and the like. It is understood that additional or alternative machine learning algorithms may be used without departing from the invention.

The application portal 254 may further comprise a web interface 270, a mobile application 271, or an API interface 272. In some embodiments, the user 102 may submit payment data, resource request data, verification data, tracking data, real-time payment requests, or the like, in the form of resource data 273 via the user device 104 via the one or more components of the application portal 254. In this way, the real-time verification system 200 may receive submissions from one or more users 102 in the form of resource data 273, and may further use the capabilities of the agent 253 in order to communicate with the distributed register database for storage of resource data 273 related to one or more real-time payments (RTPs). To generate an RTP, the real-time verification system 200 may be configured to generate one or more requests for resource transfers (RRTs) to be fulfilled by one or more users. An RRT may be an electronic request for resource transfer generated for (or by) a third party wishing to receive resources from user in response to the user's procurement of an supply chain item from the third party, or some other condition precedent. Once generated, the RRTs may be transmitted to the resource repository (e.g., account) of the user. Based on the requirements of each RRT, the user may be obligated to execute a resource transfer. As such, the resource data 273 submitted via the application portal 254 may be relevant to the procurement of an supply chain item, or the fulfillment of some condition. Various resource data 273 may be relevant to one or more smart contracts created on the distributed register database and cause resources to be released, or the like. It is understood that the application portal may interact with the user device 104 via a web interface 270, mobile application 271, or an API interface 272, and in some embodiments a portion, complementary component, or all of each of these application portal aspects may exist locally on the user device as an entity application 1048 or user application 351, as discussed in FIG. 3.

The communication device 244 may generally include a modem, server, transceiver, and/or other devices for communicating with other devices on the network 101. The communication device 244 may be a communication interface having one or more communication devices configured to communicate with one or more other devices on the network 101, such as the real-time verification system 200, the user device 104, other processing systems, data systems, etc.

Additionally, the processing device 242 may generally refer to a device or combination of devices having circuitry used for implementing the communication and/or logic functions of the real-time verification system 200. For example, the processing device 242 may include a control unit, a digital signal processor device, a microprocessor device, and various analog-to-digital converters, digital-to-analog converters, and other support circuits and/or combinations of the foregoing. Control and signal processing functions of the real-time verification system 200 may be allocated between these processing devices according to their respective capabilities. The processing device 242 may further include functionality to operate one or more software programs based on computer-executable program code 252 thereof, which may be stored in a memory device 250, such as the application portal 254 and the agent 253. As the phrase is used herein, a processing device may be “configured to” perform a certain function in a variety of ways, including, for example, by having one or more general-purpose circuits perform the function by executing particular computer-executable program code embodied in computer-readable medium, and/or by having one or more application-specific circuits perform the function. The processing device 242 may be configured to use the network communication interface of the communication device 244 to transmit and/or receive data and/or commands to and/or from the other devices/systems connected to the network 101.

The memory device 250 within the real-time verification system 200 may generally refer to a device or combination of devices that store one or more forms of computer-readable media for storing data and/or computer-executable program code/instructions. For example, the memory device 250 may include any computer memory that provides an actual or virtual space to temporarily or permanently store data and/or commands provided to the processing device 242 when it carries out its functions described herein.

FIG. 3 illustrates a block diagram of the user device associated with a real-time verification system, in accordance with embodiments of the present invention. The user device 104 may include a user mobile device or the like. A “mobile device” 104 may be any mobile communication device, such as a cellular telecommunications device (i.e., a cell phone or mobile phone), personal digital assistant (PDA), a mobile Internet accessing device, or another mobile device including, but not limited to portable digital assistants (PDAs), pagers, mobile televisions, laptop computers, cameras, video recorders, audio/video player, radio, GPS devices, any combination of the aforementioned devices.

The user device 104 may generally include a processing device or processing device 1042 communicably coupled to devices such as, a memory device 1046, user output devices 1045 (for example, a user display or a speaker), user input devices 1044 (such as a microphone, keypad, touchpad, touch screen, and the like), a communication device or network interface device 360, a positioning system device 1043, such as a geo-positioning system device like a GPS device, an accelerometer, and the like, one or more chips, and the like.

The processing device 1042 may include functionality to operate one or more software programs or applications, which may be stored in the memory device 320. For example, the processing device 1042 may be capable of operating applications such as a user application 351, an entity application 1048, or a web browser application. The user application 351 or the entity application may then allow the user device 104 to transmit and receive data and instructions to or from the third party system 400, real-time verification system 200, and the managing entity system 500, and display received information via a graphical user interface of the user device 104. The user application 1047 may further allow the user device 104 to transmit and receive data to or from the managing entity system 500 (for example, via wireless communication or NFC channels), data and instructions to or from the real-time verification system 200, web content, such as, for example, location-based content and/or other web page content, according to a Wireless Application Protocol (WAP), Hypertext Transfer Protocol (HTTP), and/or the like. The user application 1047 may allow the managing entity 500 to present the user 102 with a plurality of recommendations, suggestions, requests, blockchain data, graph data, statistics, and/or the like.

The processing device 1042 may be configured to use the communication device 1041 to communicate with one or more devices on a network 101 such as, but not limited to the third party system 400, the real-time verification system 200, and the managing entity system 500. In this regard the processing device 1042 may be configured to provide signals to and receive signals from the communication device 1041. The signals may include signaling information in accordance with the air interface standard of the applicable BLE standard, cellular system of the wireless telephone network and the like, that may be part of the network 101. In this regard, the user device 104 may be configured to operate with one or more air interface standards, communication protocols, modulation types, and access types. By way of illustration, the user device 104 may be configured to operate in accordance with any of a number of first, second, third, and/or fourth-generation communication protocols and/or the like. For example, the user device 104 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Universal Mobile Telecommunications System (UMTS), CDMA2000, wideband CDMA (WCDMA) and/or time division-synchronous CDMA (TD-SCDMA), with fourth-generation (4G) wireless communication protocols, and/or the like. The user device 104 may also be configured to operate in accordance with non-cellular communication mechanisms, such as via a wireless local area network (WLAN) or other communication/data networks. The user device 104 may also be configured to operate in accordance Bluetooth® low energy, audio frequency, ultrasound frequency, or other communication/data networks.

The communication device 1041 may also include a user activity interface presented in user output devices 1045 in order to allow a user 102 to execute some or all of the processes described herein. The application interface may have the ability to connect to and communicate with an external data storage on a separate system within the network 101. The user output devices 1045 may include a display (e.g., a liquid crystal display (LCD) or the like) and a speaker 334 or other audio device, which are operatively coupled to the processing device 1042. The user input devices 1044, which may allow the user device 104 to receive data from the user 102, may include any of a number of devices allowing the user device 104 to receive data from a user 102, such as a keypad, keyboard, touch-screen, touchpad, microphone, mouse, joystick, other pointer device, button, soft key, and/or other input device(s).

The user device 104 may also include a memory buffer, cache memory or temporary memory device 1046 operatively coupled to the processing device 1042. Typically, one or more applications 351 and 352, are loaded into the temporarily memory during use. As used herein, memory may include any computer readable medium configured to store data, code, or other information. The memory device 1046 may include volatile memory, such as volatile Random Access Memory (RAM) including a cache area for the temporary storage of data. The memory device 420 may also include non-volatile memory, which can be embedded and/or may be removable. The non-volatile memory may additionally or alternatively include an electrically erasable programmable read-only memory (EEPROM), flash memory or the like.

In some instances, various features and functions of the invention are described herein with respect to a “system.” In some instances, the system may refer to the real-time verification system 200 performing one or more steps described herein in conjunction with other devices and systems, either automatically based on executing computer readable instructions of the memory device 250, or in response to receiving control instructions from the managing entity system 500. In some instances, the system refers to the devices and systems on the operating environment 100 of FIG. 1. The features and functions of various embodiments of the invention are be described below in further detail.

It is understood that the servers, systems, and devices described herein illustrate one embodiment of the invention. It is further understood that one or more of the servers, systems, and devices can be combined in other embodiments and still function in the same or similar way as the embodiments described herein.

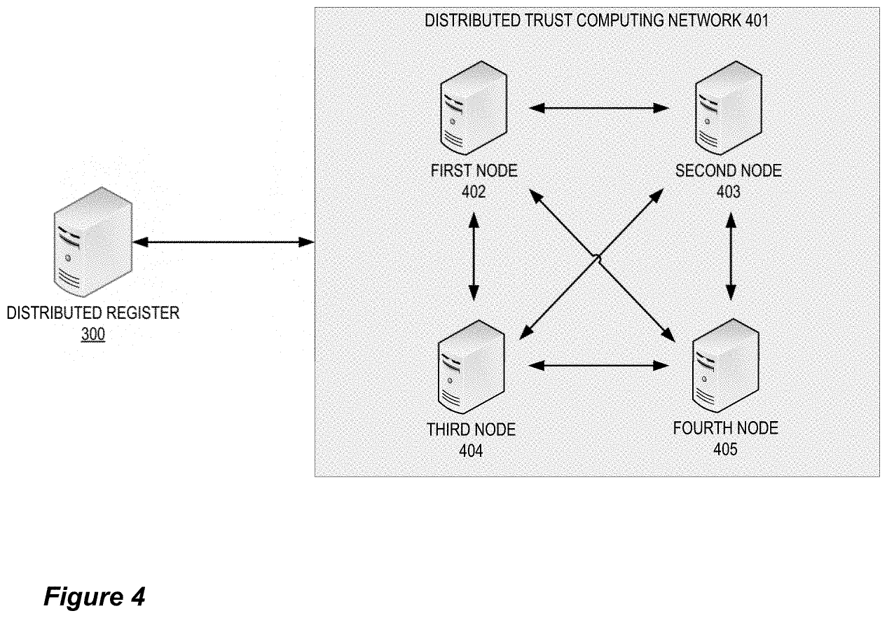

FIG. 4 is a block diagram illustrating an operating environment for the distributed trust computing network 401, in accordance with some embodiments of the present disclosure. In particular, the operating environment may include a plurality of distributed register nodes 402, 403, 404, and 405 in operative communication with one another within the distributed trust computing network 401. The distributed trust computing network 401, as well as other networks as described herein, may operate communicatively between nodes using a global area network (GAN), such as the Internet, a wide area network (WAN), a local area network (LAN), or any other type of network or combination of networks. The network may provide for wireline, wireless, or a combination wireline and wireless communication between devices on the network.

The first distributed register node 402, the second distributed register node 403, the third distributed register node 404, and the fourth distributed register node 405 may be computing systems which collectively validate information on the distributed register 300. Accordingly, the distributed register nodes 402, 403, 404, and 405 are typically networked terminals or servers, but may also be desktop computers, laptops, smartphones or smart devices, IoT devices, or the like, or any combination thereof. Typically, each distributed register node 402, 403, 404, and 405 hosts a complete copy of the distributed register. The contents of the various copies of the distributed register hosted on the distributed register nodes 402, 403, 404, and 405 may be updated to be consistent with one another via a consensus algorithm executed by the distributed register nodes 402, 403, 404, and 405. In this way, a complete and verified copy of the distributed register may remain accessible even if the copy of the distributed register stored on one or more distributed register nodes 402, 403, 404, and 405 become inaccessible (e.g., due to being offline, experiencing high network latency, or the like) or corrupted (e.g., due to hardware/software errors, unauthorized modification of distributed register contents, or the like). It is understood that while four nodes are depicted in the embodiment shown in FIG. 3, there may be any number of nodes (“N” number of nodes) which make up the distributed trust computing network 401 and operate to validate entries and maintain a complete copy of the distributed register.

The operating environment may further comprise the distributed register 300 which may be in operative communication with the distributed register nodes 402, 403, 404, and 405 of the distributed trust computing network 401. The distributed register 300 may be a computing system that submits data to the nodes 402, 403, 404, and 405 in the form of proposed data records to be added to the distributed register 300. The distributed register 300 may further be used to manage interjectors and receive notifications regarding the data within the distributed register. Accordingly, the distributed register 300 may be one or more desktop computers, laptop computers, smartphones, tablets, smart devices, IoT devices, single board computers, or the like. In some embodiments, distributed register 300 may be operated by a user within the entity. In other embodiments, the distributed register 300 may automatically perform various functions to manage submitted or retrieved data or interjectors.

The submission and receipt of data between distributed register 300 and the distributed trust computing network 401 may be achieved through one or more nodes described in FIG. 1 (e.g., the node 1, the node 2, or the like) and immediately processed for submission to the distributed register, such that that data hops or manual data touchpoints are reduced to preferably zero, allowing the system to maintain maximum integrity of data validation. The automated flow of permissioned ledger data allows the leveraging of distributed register technology and distributed register based services directly to entity side systems. The distributed register 300 may be designed to provide access to data stored on the distributed register to third party systems as well. For instance, the third party system may comprise an overseeing entity conducting an investigation or study of data history or patterns within the data stored on the distributed register.

It should be understood by those having ordinary skill in the art that although the distributed register nodes 402, 403, 404, and 405, and/or the distributed register 300 are depicted as single units, each of the depicted components, or sub-components therein, may represent multiple units. In some embodiments, a given computing system as depicted in FIG. 3 may represent multiple systems configured to operate in a distributed fashion. In other embodiments, the functions of multiple computing systems may be accomplished by a single system. For instance, the functions of the data monitoring system 106 may be accomplished by one or more of the distributed register nodes 402, 403, 404, and 405. It should further be understood that even though reference may be made to a single “distributed trust computing network 401,” all singular usages of “distributed trust computing network” or “distributed register” may also refer to multiple distributed registers. For instance, separate distributed registers may be stored on the nodes 402, 403, 404, and 405 on a per-application or per-parameter basis.

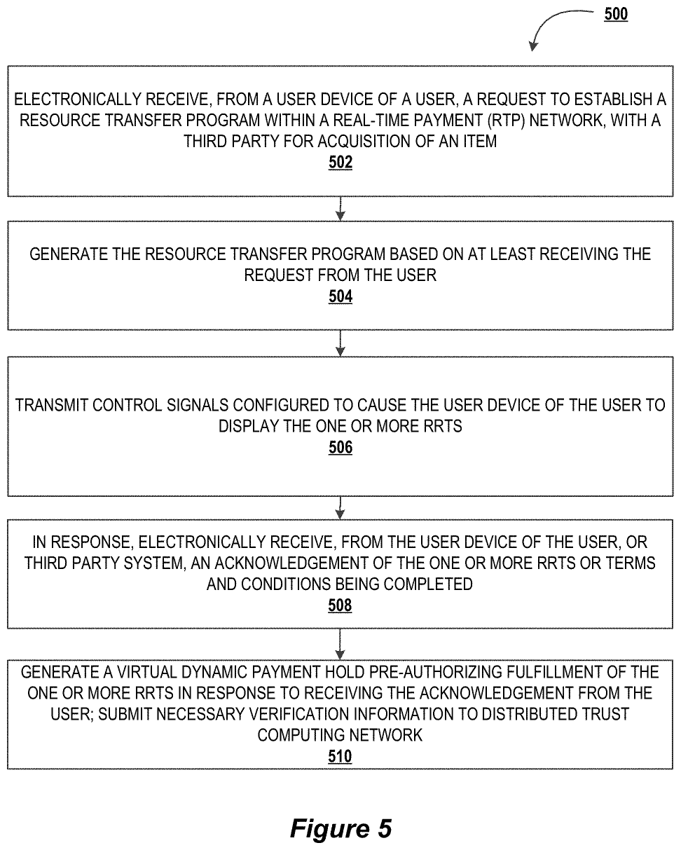

FIG. 5 is a process flow diagram 500 for generating and executing pre-authorized request for conditional resource transfers within a real-time resource transfer network, in accordance with some embodiments of the invention. As shown in block 502, the process flow includes electronically receiving, from a user device 104 of a user 102, a request to establish a resource transfer program within an RTP network, with a third party system 400, for acquisition of an supply chain item. For example, the user 102 may have purchased an item from the third party and wish to transfer payment for the item to the third party using the RTP network, where payments are fulfilled in real-time based on conditions of the supply chain being fulfilled.

In some embodiments, a resource transfer program may be a structured set up whereby the user may execute resource transfers in response to the acquisition of the item within mutually accepted conditions, such as within a specific time frame. For instance, in some embodiments, the user 102 may have ordered goods from a supplier for stocking products in a storefront owned by the user 102. In other embodiments, the user 102 may be a consumer, or the like, who has ordered one or more items for delivery (e.g., food from a delivery service, a product from a website, or the like).

In some embodiments, an RTP network may be a secure digital infrastructure overlaid on existing resource transfer infrastructures to facilitate real-time resource transfers. Using the RTP network, a user 102 may request or initiate resource transfers. In this way, the RTP network enables users, entities, and third parties to connect real-time resource transfers to a purchasing experience, billing scenario, or accounts payable process. In some other embodiments, the RTP network may be integrated into the core functionality of the managing entity system 500 in the form of real-time resource transfers that provide transfer flows and rules to participate in the RTP network. From a central infrastructure view, the provision of the flows and rules framework for the service is either a capability within the faster payments scheme or system itself, a closely related offering by the same managing entity system 500.

In some embodiments, the resource transfer program may be a recurring action that requires one or more periodic resource transfers. For purposes of the invention, a recurring action may refer to an arrangement whereby a user 102 agrees to a contract to acquire an item by paying an initial installment (e.g., 20% of the total) and repays the balance of the of the price of the item with interest over a period of time. In other embodiments, the resource transfer program may include the user 102 paying for an item only after some condition has been verified, such as the item being manufactured, shipped, delivered, or the like. The real-time verification system 200 may receive resource data 273 from the user 102, or gather this information via agent 253 (e.g., intelligently gather information scraped from a shipping company's website, gather information from a supply chain logistics software program, or the like) order to verify that these conditions have been met.

Next, as shown in block 504, the process flow includes generating the resource transfer program based on at least receiving the request from the user 102. To generate the resource transfer program, the real-time verification system 200 may be configured to generate one or more requests for resource transfers (RRTs) to be fulfilled by the user 102. An RRT may be an electronic request for resource transfer generated for (or by) a third party system 400 wishing to receive resources from user 102 in response to the user's procurement of an item from the third party. Once generated, the RRTs may be transmitted to the resource repository (e.g., account, or the like) of the user 102. Based on the requirements of each RRT, the user 102 may be obligated to execute a resource transfer.

To generate the RRTs, in some embodiments, the system may be configured to retrieve from the request, resource transfer information associated with the resource transfer program. In some embodiments, the resource transfer information may include at least information associated with the user 102, information associated with the item, and information associated with the third party system 400. In addition, the system may be configured to electronically receive, from a computing device of the third party system 400, one or more terms or conditions precedent associated with the resource transfer program. In some embodiments, the one or more terms associated with the resource transfer program may include, for each of the one or more RRTs, at least a resource transfer date, a resource transfer time, and a resource transfer amount, an item shipping date, an item delivery date, or the like. In response, the system 200 may be configured to generate the one or more RRTs based on at least the resource transfer information and one or more terms associated with the resource transfer program. Each RRT may be associated with a set of requirements, which when met, trigger an action automatically via a smart contract on the distributed trust computing network 401. For example, an RRT may include a date requirement on which the item is to be shipped. Once the data requirement is met, the RRT is activated, which results in automatic transfer of payment from the user's account to the third party's account based on the rest of the requirements (e.g., amount of funds, specific account, or the like) listed in the RRT.

In embodiments where the resource transfer program is a recurring action, the system may be configured to generate the one or more RRTs for the one or more periodic resource transfers. For example, the user may have purchased an item from the third party (e.g., merchant) and may wish to provide payment to the third party in installments at specific milestones throughout a supply chain. The RTP network provides the user with the option to provide payment to the third party in the form of real-time payments, an instantaneous funds transmission medium. To this end, the user may request that for each installment, the system generate an RRT that provides information associated with the installment and is fulfilled automatically when certain conditions are met (e.g., pay 20% at time of order, pay additional 10% at time of shipping, pay additional 70% at time of actual delivery, inspection of delivery, or the like).

Next, as shown in block 506, the process flow includes transmitting control signals configured to cause the user device 104 of the user 102 to display the one or more RRTs. In some embodiments, the user may review the RRTs for information accuracy and provide an acknowledgement indicating acceptance of the terms of procurement of the item. As further shown in block 508, the process flow includes in response, electronically receiving, from the user device 104 of the user 102, or from the third party system 400, an acknowledgement of the one or more RRTs or terms being completed. In some embodiments, the acknowledgement may be intelligently determined by the real-time verification system 200. For instance, after the user 102 or the third party system 400 has provided resource data 273 indicating shipping tracking information for an item, the system 200 may periodically use this data to check for updates in shipment status via agent 253. In some embodiments, the system 200 may verify that a product has been shipped, signed for at delivery, or the like, and submit this verification information to the distributed trust computing network 401. At this stage, the submission of certain verification information may trigger the automatic release of resource according to a smart contract created for the RRT.

Next, as shown in block 510, the process flow includes generating a virtual dynamic resource transfer hold pre-authorizing fulfillment of the one or more RRTs in response to receiving the acknowledgement from the user 102. By generating a virtual dynamic resource transfer hold, the system may be configured to enable automatic authorization of resource transfer at each term completion point (trigger event), and may submit necessary verification of the term completion to the distributed trust computing network. In some embodiments, the system 200 may interface via an API protocol, or the like, to request or resource data 273 or verification data from a third party system 400, such as a delivery service (e.g., food delivery service, online merchant, or the like).

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EEPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out the specialized operations of the present invention may be required on the specialized computer include object-oriented, scripted, and/or unscripted programming languages, such as, for example, Java, Perl, Smalltalk, C++, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A system for generating pre-authorized request for conditional resource transfers within a real-time resource transfer network, the system comprising:
at least one non-transitory storage device; and
at least one processing device coupled to the at least one non-transitory storage device, wherein the at least one processing device is configured to:
electronically receive, from a user device of a user, a request to establish a resource transfer program within a real-time payment (RTP) network, with a third party for acquisition of an item or product;
generate the resource transfer program based on at least receiving the request from the user, wherein generating further comprises generating one or more requests for resource transfers (RRTs) to be fulfilled by the user;
transmit control signals configured to cause the user device of the user to display the one or more RRTs;
in response, electronically receive, from the user device of the user, an acknowledgement of the one or more RRTs;
electronically receive resource data verifying completion of one or more conditions precedent from the user or the third party, wherein the conditions precedent each correspond to a percentage installment of a total resource amount based on fulfillment of an action related to a product;
submit a proposal to a distributed ledger containing the resource data; and
authorize fulfillment of at least a portion of resources of the one or more RRTs in response to receiving the resource data from the user or the third party.

2. The system of claim 1, wherein the at least one processing device is further configured to:
retrieve from the request, resource transfer information associated with the resource transfer program, wherein the resource transfer information comprises at least information associated with the user, information associated with the item or product, and information associated with the third party.

3. The system of claim 2, wherein the at least one processing device is further configured to:
electronically receive, from a user device of the third party, the one or more conditions precedent associated with the resource transfer program; and
generate the one or more RRTs based on at least the resource transfer information and the one or more conditions precedent associated with the resource transfer program.

4. The system of claim 3, wherein the one or more conditions precedent associated with the resource transfer program comprise, for each of the one or more RRTs, at least a resource transfer date, a resource transfer time, a resource transfer amount, and an action required on the user or third party's behalf prior to authorization of the resource transfer amount.

5. The system of claim 2, wherein the at least one processing device is further configured to:
determine that the resource transfer program is a recurring action comprising one or more periodic resource transfers; and
generate the one or more RRTs for the one or more periodic resource transfers.

6. The system of claim 5, wherein the at least one processing device is further configured to:
at each recurring period, automatically authorize, via the RTP network, fulfillment of at least one of the one or more RRTs, wherein authorizing further comprises executing a real-time resource transfer of at least one of the one or more periodic resource transfers.

7. The system of claim 6, wherein the at least one processing device is further configured to:
transmit control signals configured to cause the computing device of the user to display a notification indicating the fulfillment of at least one the conditions precedent, and indicating the authorization of at least a portion of resources.

8. A computer program product for generating pre-authorized request for conditional resource transfers within a real-time resource transfer network, the computer program product comprising a non-transitory computer-readable medium comprising code causing a first apparatus to:
electronically receive, from a user device of a user, a request to establish a resource transfer program within a real-time payment (RTP) network, with a third party for acquisition of an item or product;
generate the resource transfer program based on at least receiving the request from the user, wherein generating further comprises generating one or more requests for resource transfers (RRTs) to be fulfilled by the user;
transmit control signals configured to cause the user device of the user to display the one or more RRTs;
in response, electronically receive, from the user device of the user, an acknowledgement of the one or more RRTs;
electronically receive resource data verifying completion of one or more conditions precedent from the user or the third party, wherein the conditions precedent each correspond to a percentage installment of a total resource amount based on fulfillment of an action related to a product;
submit a proposal to a distributed ledger containing the resource data; and
authorize fulfillment of at least a portion of resources of the one or more RRTs in response to receiving the resource data from the user or the third party.

9. The computer program product of claim 8, wherein the first apparatus is further configured to:
retrieve from the request, resource transfer information associated with the resource transfer program, wherein the resource transfer information comprises at least information associated with the user, information associated with the item or product, and information associated with the third party.

10. The computer program product of claim 9, wherein the first apparatus is further configured to:
electronically receive, from a user device of the third party, the one or more conditions precedent associated with the resource transfer program; and
generate the one or more RRTs based on at least the resource transfer information and the one or more conditions precedent associated with the resource transfer program.

11. The computer program product of claim 10, wherein the one or more conditions precedent associated with the resource transfer program comprise, for each of the one or more RRTs, at least a resource transfer date, a resource transfer time, a resource transfer amount, and an action required on the user or third party's behalf prior to authorization of the resource transfer amount.

12. The computer program product of claim 9, wherein the first apparatus is further configured to:
determine that the resource transfer program is a recurring action comprising one or more periodic resource transfers; and
generate the one or more RRTs for the one or more periodic resource transfers.

13. The computer program product of claim 12, wherein the first apparatus is further configured to:
at each recurring period, automatically authorize, via the RTP network, fulfillment of at least one of the one or more RRTs, wherein authorizing further comprises executing a real-time resource transfer of at least one of the one or more periodic resource transfers.

14. The computer program product of claim 13, wherein the first apparatus is further configured to:
transmit control signals configured to cause the computing device of the user to display a notification indicating the fulfillment of at least one the conditions precedent, and indicating the authorization of at least a portion of resources.

15. A method for generating pre-authorized request for conditional resource transfers within a real-time resource transfer network, the method comprising:
electronically receiving, from a user device of a user, a request to establish a resource transfer program within a real-time payment (RTP) network, with a third party for acquisition of an item or product;
generating the resource transfer program based on at least receiving the request from the user, wherein generating further comprises generating one or more requests for resource transfers (RRTs) to be fulfilled by the user;
transmitting control signals configured to cause the user device of the user to display the one or more RRTs;
in response, electronically receiving, from the user device of the user, an acknowledgement of the one or more RRTs;
electronically receiving resource data verifying completion of one or more conditions precedent from the user or the third party, wherein the conditions precedent each correspond to a percentage installment of a total resource amount based on fulfillment of an action related to a product;
submitting a proposal to a distributed ledger containing the resource data; and
authorizing fulfillment of at least a portion of resources of the one or more RRTs in response to receiving the resource data from the user or the third party.

16. The method of claim 15, wherein the method further comprises:
retrieving from the request, resource transfer information associated with the resource transfer program, wherein the resource transfer information comprises at least information associated with the user, information associated with the item or product, and information associated with the third party.

17. The method of claim 16, wherein the method further comprises:
electronically receiving, from a user device of the third party, the one or more conditions precedent associated with the resource transfer program; and
generating the one or more RRTs based on at least the resource transfer information and the one or more conditions precedent associated with the resource transfer program.

18. The method of claim 17, wherein the one or more conditions precedent associated with the resource transfer program comprise, for each of the one or more RRTs, at least a resource transfer date, a resource transfer time, a resource transfer amount, and an action required on the user or third party's behalf prior to authorization of the resource transfer amount.

19. The method of claim 16, wherein the method further comprises:
determining that the resource transfer program is a recurring action comprising one or more periodic resource transfers; and
generating the one or more RRTs for the one or more periodic resource transfers.

20. The method of claim 19, wherein the method further comprises:
at each recurring period, automatically authorize, via the RTP network, fulfillment of at least one of the one or more RRTs, wherein authorizing further comprises executing a real-time resource transfer of at least one of the one or more periodic resource transfers.
